(19) United States
(12) Patent Application Publication
(10) Pub. No.: US 2009/0106047 A1
(43) Pub. Date: Apr. 23, 2009

(54) Integrated solution for diagnostic reading and reporting

(76) Inventors: Susanne Bay, Erlangen (DE); Christoph Braun, Rosenheim (DE); Beate Schwichtenberg, Munich (DE)

Correspondence Address: HARNESS, DICKEY & PIERCE, P.L.C., P.O.BOX 8910, RESTON, VA, 20195, US

(21) Appl. No.: 12/285,756

(22) Filed: Oct. 14, 2008

(30) Foreign Application Priority Data
Oct. 19, 2007 (DE) 10 2007 050 184.8

(51) Int. Cl. G06Q 50/00; G06F 19/00

(52) U.S. Cl. 705/2

(57) ABSTRACT

A method, a computer program product and a system are disclosed for producing a medical report. In at least one embodiment, the method includes provisioning medical examination data in a display context which has been selected from a multiplicity of display contexts; capturing diagnosis data which relate to the selected display context and to the medical examination data; and automatic conversion of the diagnosis data into a report context, the report context being explicitly associated with the selected display context.

### PRIORITY STATEMENT

The present application hereby claims priority under 35 U.S.C. §119 on German patent application number DE 10 2007 050 184.8 filed Oct. 19, 2007, the entire contents of which is hereby incorporated herein by reference.

### BACKGROUND

The aim of radiological diagnostics is to prove or eliminate a suspected diagnosis. The aim of the diagnostic process is to determine the state of the patient in respect of a great variety of clinical aspects, with imaging methods being used as evidence. In this process, the diagnostic tasks of the radiologist are to view radiological images and to identify positive and negative clinical findings. The tasks of the radiologist also include qualifying something (e.g. as malignant), quantifying something (e.g. the physical extent, or the volume) and comparing current findings with earlier findings.

These tasks are performed by using visual interpretation or measurement tools and applications. The results of the clinical tasks need to be documented, assessed for the further treatment and finally communicated in a report to a referring doctor.

One primary task of a radiologist is the efficient performance of the diagnostic and documentary/reporting tasks. There are four primary aspects which need to be taken into account when the efficiency of the diagnostic task is evaluated:

1) the compromise between accuracy and productivity in the diagnostic process
2) the ability to focus the visual attention on images (reduction of times in which the viewer looks away)
3) the integration of image processing results in the diagnostic process
4) the transfer of work results from one person to the next.

The problem faced by the radiologist is:

1) there are no standard means which address the compromise between accuracy and productivity.
2) simultaneous (synchronous) reading and reporting mean that the radiologist is forced to look away from the images.
3) image processing functionality is available only with separate software or even separate hardware, but not on the reading console or the reading user interface.
4) the transfer of results from one person to the next is not efficient.

The following sections provide details for each aspect. They explain what obstacles stand in the way of productive work today.

In respect of the aim of confirming or eliminating a clinical picture, it is firstly important to form the radiological diagnosis with the greatest level of accuracy. It is therefore essential not to overlook any findings and to draw the correct conclusion in order to prevent an incorrect diagnosis and treatment errors. Besides the accuracy, the radiologist is also required to use the most efficient method for the diagnosis activity in order to shorten the diagnosis time. In addition, it is a complex matter to document the findings, which is preferably done together in coordination with the reading workflow (see FIG. 1). Finally, work is involved in communicating the findings to the referring doctor efficiently and comprehensibly.

Secondly, uninterrupted visual attention and the optimum display of radiological supporting documents (e.g. images) are of great importance for simplifying the visual interpretation of both images and measurement data. One requirement for the diagnostic process would be the reduction of the times in which the user looks away from the findings in the images and the measurement results (e.g. cardiac output curve) during the review. However, the visual review process contains interruptions and requires activities such as changing settings (e.g. MIP filters) and views (e.g. 2:1 layout), selecting and starting tools (e.g. volume slice thickness), selecting and arranging images on screen layouts, and preparing visual displays. These activities tend to shift and tie the operator's attention. However, these activities are essentially software preparations in order to allow the radiologist to produce a diagnosis.

During reading, it must be possible to produce the report using voice recognition or input devices (e.g. keyboard) in order to produce text. Software tools also need to be started in order to provide measurements. For reporting, the user needs to shift his visual attention to and fro between the report user interface and the reading user interface, regardless of whether synchronous or asynchronous reporting is involved (FIG. 1).

Times at which the user looks away from the images also crop up during reporting, these being caused by the transfer of information and by the inspection of the correct documentation for findings in another user interface, namely the report user interface. In addition, the user's memory capacities are taken up during the transfer of results from one environment to the other. Although it would be possible to set limits such that the user can only dictate the text and electronic or computer-aided transcription (voice recognition) is dispensed with, with the transcription instead being undertaken conventionally by typists, this is not a practical solution, since the typing work results in the whole time required for the reporting becoming longer. In addition, the reporting doctor needs to view the transcript again for the purpose of correction. Realtime reporting using electronic voice recognition is therefore preferred.

A third problem relates to the integration of image processing into the reading and report process, such as the production of visual displays (e.g. segmentations) and the automatic production of measurements (evaluation algorithms, e.g. CAD or stenosis quantification). Additional visual displays or image processing results (e.g. penumbra evaluation) are produced from the recorded image data. These image processing results support the diagnostic process with highly developed visual displays, computer-aided measurements or automatic detections (which cannot be achieved at the same speed and level of accuracy by human operators).

Furthermore, image processing results (e.g. 3D key images) assist the recipient in understanding the clinical state of the patient. At present, image processing applications are integrated into the reading/reporting landscape at a low technical level. The use of image processing applications for reading entails delays and interruptions, since the processing needs to take place on separate software systems (hardware and software applications). This necessitates a change of data and context. These applications are therefore not integrated into the daily workflow of the operator, or the integration of image processing results is dependent on the radiologist. In actual fact, image processing results should be provided at a point in the diagnostic process when the results provide information and contribute to answering a clinical question.

Fourthly, several roles (technical system and human roles) are involved in the imaging or the therapeutic workflow for a patient in a radiology department. To speed up the rate at which work is done, certain work steps need to be executed in parallel (in a distributed manner) or transferred to other agents who have particular competences. To ensure due benefit in the work distribution, the results from each role need to be put back into the reading workflow of the radiologist and/or documented in a report.

There is currently not yet an integrated solution for reading and reporting tasks. Instead, the reading task and the report task involve a classical distinction being made between an image reading and archiving system (PACS—Picture Archiving and Communication System) and a reporting and patient management system (RIS—Radiology Information System). There are some approaches which attempt to make parts of the diagnostic task more efficient:

a solution to improve the accuracy of diagnosis provides for the use of prepared reports with normal (healthy) findings which serve as guidelines through the reading and reporting process.

To reduce the complexity of preparation, DICOM hanging protocols are used to prepare a start layout. The assignment of DICBM hanging protocols is handled via attributes such as modality/imaging method or body part (instead of indication). Other solutions display all the images on the reading monitors and/or provide protocols for 3D processing and reading activity.

However, there is no generally valid standard. The solution to the problem of how an efficient and accurate diagnosis can be produced remains a choice for the reporting radiologist and his occupational capabilities.

There are no solutions which facilitate the integration of image processing results into the diagnostic process and the transfer of work results from one person to the next. Instead, work units are processed on different clinical machines and by different roles which all contribute to the patient workflow.

### SUMMARY

In at least one embodiment of the present invention, a way is demonstrated in which the production of medical reports can be made simpler, faster and more uniform.

In at least one embodiment, a reporting method or a reporting system or a diagnosis screen workstation is disclosed, for example for the medical sector.

Embodiments of the invention are described below with reference to the method-based solution. Advantages, features or alternative embodiments mentioned in this context may accordingly also be transferred to the other solutions of embodiments of the invention. Accordingly, the reporting system and the screen workstation can also be developed further by features which are mentioned in connection with the description of the method or by features from the subclaims relating to the method.

First, it will be noted at this juncture that the solution according to at least one embodiment of the invention is, in principle, not limited to the listing order of the method steps in the method claims. Although the listing order matches the execution order of the steps in the example embodiment, it is equally possible in alternative embodiments to execute individual method steps in parallel or with timing overlaps.

In at least one embodiment, a method for producing a medical report comprises:

provision of medical examination data in a display context which has been selected from a multiplicity of display contexts;

capture of diagnosis data which relate to the selected display context and to the medical examination data;

automatic conversion of the diagnosis data into a report context, the report context being explicitly associated with the selected display context.

To allow better understanding of the embodiments of the present invention, a few concepts of the method are defined below.

A medical report is the result of a diagnostic process, the aim of which is to determine the state of a patient in respect of a multiplicity of clinical aspects. In modern medicine, imaging methods or methods of diagnostic radiology are frequently used for this purpose. One aim of diagnostic radiology is to confirm or eliminate a suspected diagnosis. The data produced by the imaging methods, particularly X-ray images, MR scans or ultrasound recordings, for example, form part of the medical report and are used particularly for the documentation and reproducibility of the diagnostic process. Within the context of the present application, the data produced by imaging methods are referred to as examination data.

A radiologist or other suitable expert has the task of interpreting or appraising the examination data in respect of clinical pictures. The results of the appraisal of the examination data are also included in the report. In appraising the examination data, it is the task of the radiologist to view and assess radiological images and to identify positive and negative findings, to qualify them (e.g. as “malignant”), to quantify them (e.g. physical extent) and to compare current findings with earlier findings.

A display context summarizes the examination data which are usefully displayed jointly for a particular diagnostic activity of the radiologist. A display context contains details about the diagnostic activity for which it is responsible and a list or other suitable data structure which shows the examination data which are to be displayed jointly on the basis of the display context. To this end, the examination data need to be standardized and marked with a descriptor, so that a display context can address particular examination data by naming a particular descriptor.

The display context is selected for a particular diagnostic activity from a multiplicity of display contexts. That is to say that for each diagnostic activity a particular display context is selected which requests or retrieves the examination data required for performing the diagnostic activity and displays them for a user.

Within the context of the present application, the diagnosis data are understood to mean data which are produced by the user in the course of the appraisal of the examination data and usually result in a conclusion. The described method or system for reporting does not relieve the user of the actual diagnosis work. It is the responsibility of the user to appraise and to draw medical conclusions. However, the user is provided with support by the method according to the invention or the system according to the invention by virtue of the information produced by the user being associated automatically.

Besides the appraisal of the examination data by the user, (simple) intermediate steps can also take place automatically by virtue of the examination data being supplied to a program which performs calculations or analyses on the examination data.

A report context relates to the report to be produced and stipulates what information the report needs to contain and possibly the order of said information. In a similar manner to the display context, the report context is selected from a multiplicity of report contexts and reflects a particular diagnostic activity or the result thereof. An association between display context and report context allows diagnosis data and/or examination data which are present in a display context to be automatically converted or transferred to a report context.

The method according to at least one embodiment of the invention maps a diagnostic activity which is displayed to a user using a display context onto the reporting. This allows data to be interchanged between the display (the display contexts) and the report (the report contexts). This achieves a high level of integration between the display area and the report area.

The display context may comprise a multiplicity of diagnosis data fields, and the report context may comprise a multiplicity of report data fields. Each report data field from the multiplicity of report data fields may have a respective associated diagnosis data field explicitly associated with it from the multiplicity of the display data fields.

In at least one embodiment, the invention includes:

1) structuring the radiological reading and report process into the answering of clinical questions,
2) using the underlying structure of answering clinical questions for optimized design of the reading and report user interface,
3) integrating the reading and reporting activity on the basis of this underlying joint process,
4) improving the diagnosis by drafting an ordered review process in a plurality of review steps.

The basic idea is to consider the radiological diagnosis and the underlying cognitive process as a sequential and schematic evaluation process.

To be able to support finer division of the diagnosis activity, both the display context and the report context have sub units in the form of diagnosis data fields or report data fields. The association between the display area and the report area continues for the diagnosis data fields and the report data fields.

The method may comprise a further method step of combining each report data field from the multiplicity of the report data fields with the respective associated diagnosis data field. The method step of combination can be performed before the method step of automatic conversion.

The method step of combination initializes the association between the display context and the report context, and possibly their internal data fields.

The method may comprise a further method step of providing at least one clinical question in the display data structure, which is performed before the step of providing the display context. In this case, the method step of the capture of diagnosis data may comprise the capture of an answer to the clinical question. In addition, the answer to the clinical question can be taken as a basis for determining a subset from the multiplicity of the display contexts, which are subsequently able to be selected for the currently valid display context.

The radiological diagnosis process and the underlying cognitive process can be regarded as a sequential and schematic assessment process. The aim of the process is to answer clinical questions and to eliminate possible reasons for a suspected diagnosis. For this reason, the clinical questions which need to be answered in order to ascertain the state of the patient, and also the clinical data (e.g. serial examination) which are relevant for each clinical question, can be determined in advance. The reading operation for the examination data is therefore divided into clinical questions and the accumulation of symptoms. The clinical questions are derived from the clinical indication for the patient (from a technical viewpoint, this is the “Requested Procedure Code”).

A clinical question is combined with one or more procedures in order to produce evidence. If lung nodules are involved, for example, different procedures are initiated in order to eliminate the reasons for the nodules gradually. The procedures map a clinical question onto one or more clinical tasks. The clinical task may be the examination of cardiac stenosis, for example, or an automatic clinical task, e.g. CAD nodule detection, which provides evidence to answer the question. On the basis of the evidence, for example “no visual detection of lung nodules”, the clinical decision is made, e.g.: “no reason for lung nodules”, and the patient is considered healthy in this respect.

The predetermination of the diagnostic process allows the user interface of the medical software to be matched thereto. The idea is that the underlying structure of answering clinical questions using combined procedures is used for the design of the reading/reporting interface. The clinical questions are presented when the display layouts are constructed and the report worksheet or the report worksheets is/are designed.

The report context may be explicitly associated with the selected display context by means of the at least one clinical question. The sequence (or the tree) of clinical questions forms a kind of backbone or execution program for the entire diagnosis process. The answers to the clinical questions are used to filter out appropriate continuations of the diagnosis process which prevent the user from wasting time by answering questions which are no longer relevant on account of previous discoveries and can therefore remain unanswered.

The display context may comprise information for the conditioning, the arrangement and/or the graphical presentation of the medical examination data. Users concerned with appraising examination data, that is to say particularly diagnostic radiologists, are used to having examination data displayed in a prescribed layout. This simplifies the appraisal for them, since they can quickly orient themselves. For example, the “DICOM hanging protocols” stipulate how the examination data (images from imaging methods) need to be arranged. The assignment of DICOM hanging protocols is achieved by means of attributes, such as modality/imaging method or body part (instead of an indication).

The diagnosis data can at least in part be captured audibly and processed by way of voice recognition. The appraisal work to be carried out by a radiologist can often be managed better and more quickly if the radiologist needs to concentrate only on the examination data and his observations. The input of text and data using a keyboard ties up a considerable amount of the radiologist's attention and slows down his work. An alternative to manual typing is to dictate the text and the data which need to appear in the report. This requires only a fraction of the radiologist's attention and is usually faster. Voice recognition converts the spoken word into a text which is suitable for computers (e.g. ASCII text). The voice recognition renders text entry by typists unnecessary and provides the text immediately after dictation or even during dictation. Depending on the quality of the voice recognition, subsequent correction by the user is also necessary in order to ensure that the content of the dictation has been recorded correctly.

During the step for converting the diagnosis data to the report context, rules for processing the diagnosis data can be executed. Where necessary and appropriate, diagnosis data can be altered, extended or processed in another way during the transmission to the report context (that is to say during the conversion). The system assists in the processing of results or findings generated manually by the user in the display context (1. free-text input by way of keyboard or voice, 2. evaluations/measured values) by virtue of these being transmitted on the basis of rules in predefined data fields of the report context. In addition, there are automatically performed evaluations which are already transmitted to the report context automatically without the need for the user to produce them himself.

Finally, the system can take measured values generated by the user and generate sentences which are then associated with a report context on the basis of the association between display context and tool (e.g. measurement using a special tool within the framework of a display context results in the following appearing in a data field: “There is a tumor with dimensions of 3 ccm”). There is at least one predefined data field in the report context so as also to associate the input of the voice recognition explicitly with the report context if the report is created purely in text form. This data field has the dictated, voice-recognized text transferred to it, so that it appears in the report.

In addition, at least one embodiment of the invention includes a system for producing a medical report. The system can also be developed with the features of the method described above.

An alternative embodiment provides a computer program product or a storage medium which is intended for storing the method described above.

### BRIEF DESCRIPTION OF THE DRAWINGS

The detailed description of the figures which follows discusses example embodiments, which are to be understood as nonlimiting, with their features and further advantages with reference to the drawing, in which:

FIG. 1 shows a flowchart for the production of medical reports which portrays the prior art,

FIG. 2 shows a graphical user interface for reading examination data, a graphical user interface for reporting, and relationships between the two graphical user interfaces,

FIG. 3 shows a display context, a report context, and relationships between the display context and the report context,

FIG. 4 shows a diagnostic evaluation process on which the reporting is based,

FIG. 5 shows the associations between clinical questions, display contexts and report contexts,

FIG. 6 shows a diagram of the software architecture, and

FIG. 7 shows an application example for an embodiment of the present invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however; that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

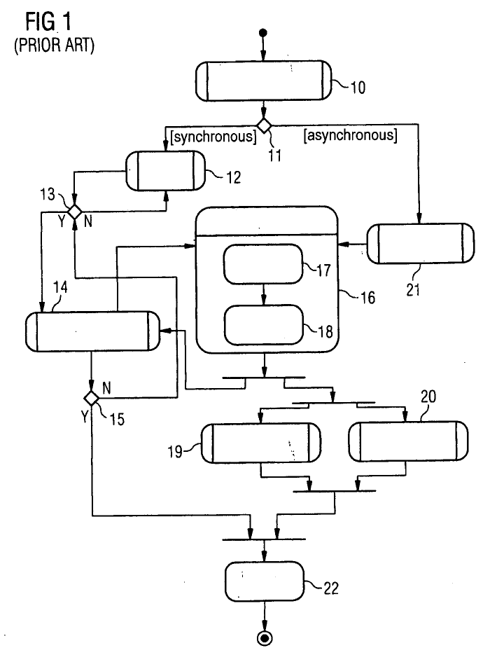

FIG. 1 shows a flowchart which contains the various steps of reporting based on the prior art. Since the reporting is part of the clinical evaluation process, it is interweaved with the reading. The left-hand side of the flowchart shows a method of reporting which is referred to as synchronous reporting. The right-hand side of FIG. 1 shows a method referred to as asynchronous reporting.

First of all, the steps of the synchronous reporting will be described.

In step 10, the reporting is started with the aim of analyzing the current study and comparing it with a prior examination. Following the path marked “synchronous”, one now arrives at step 12. In step 12, the action “read images” is performed, specifically until it is established that either the finding has been sufficiently evaluated or the user's memory capacity is exhausted. This assessment is made at the decision point 13. If none of the two aforesaid facts applies, the images continue to be read in step 12. If one of the two aforesaid facts applies or if both apply simultaneously, the progression is continued in step 14. In step 14, the user dictates the text and corrects the transcript. In this case, the visual context remains on the text. The images to be read are not considered by the user during this time. The label of synchronous reporting comes from the fact that the dictation and correction take place essentially simultaneously. At the decision point 15, it is established whether the report is complete. If not, the progression returns via the path labeled “N” to the decision point 13. If it is, the progression moves to step 22 via the path labeled “Y”, at which point the analysis is concluded.

From step 14, that is to say dictation and correction of the transcript, the progression can also move to step 16. In step 16, the reporting takes place with reference to a prior finding. Step 16 has two substeps 17 and 18. In step 17, the finding is described and in step 18 an assessment is submitted. When step 16 is complete, the progression of the synchronous reporting returns to step 14.

The progression of the asynchronous reporting is shown on the right-hand side of FIG. 1. In step 21, the user reads the images and dictates his observations, the visual focus remaining on the images. When step 21 has been concluded, the progression moves to step 16, which has already been described. Following step 16, the two parallel steps 19 and 20 are performed. Step 19 relates to the formatting and correction of the transcript. In step 20, the finding is checked using the images. The progression of the asynchronous reporting ends at step 22 (“conclude analysis”).

Both the synchronous reporting and the asynchronous reporting involve the user needing to transfer his visual attention to and fro between a reporting interface and a reading interface.

During the reporting, there are recurrently times at which the user looks away from the examination data, which is caused by the transfer of information and the checking of the correct documentation from findings on another graphical user interface. In addition, the memory capacities are put under strain during the transfer of results from one environment to the other. Although it would be possible to restrict matters such that the user is only allowed to dictate the text and electronic transcription (voice recognition) is dispensed with, with the transcription being undertaken conventionally by typists instead, this is not a practical solution, since the typing work means that the overall time required for reporting becomes longer. In addition, the reporting doctor needs to view the transcript again for the purpose of correction. Realtime reporting using electronic voice recognition is therefore preferred.

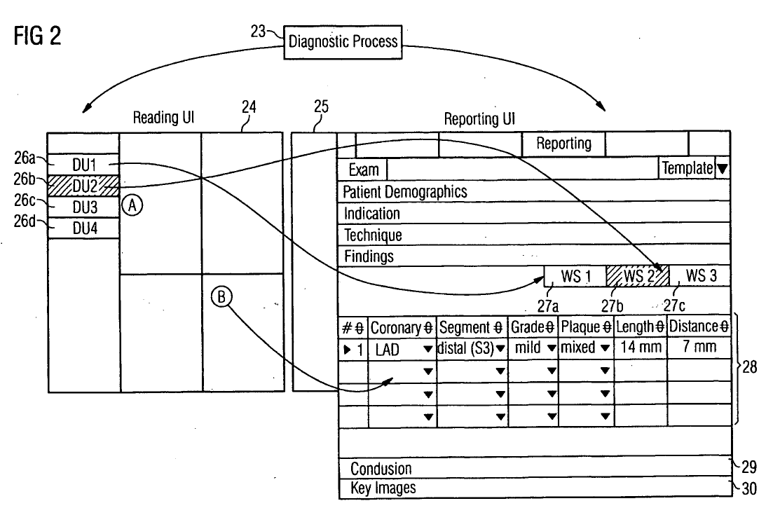

FIG. 2 shows the principle of structured reporting on two levels, namely firstly on the basis of a relationship between display contexts and report contexts or sections, and secondly on the basis of individual elements within the display and report contexts.

The left-hand side of FIG. 2 shows the graphical reading user interface 24 (“Reading UI”). The fields 26a to 26d show selection buttons for display contexts (“Display Units”, DU1 to DU4). In the situation shown, the selection button 26b is activated and therefore the examination data defined by the display context DU2 are shown to the right of this. The examination data are usually images which are created by imaging methods.

A solution for implementing an efficient clinical decision process and in order to achieve integration of reading and reporting comprises display contexts (display units—DUs). A display context is a generic term from the point of view of use. The display contexts are prepared data layouts which are accessed using the user interface. Display contexts provide the radiologist with means which he requires for performing clinical tasks, i.e. providing evidence and answering clinical questions (e.g. eliminating a pulmonary tumor).

Display contexts arrange image evidence to reduce the complexity of preparation (1), display image data in optimum fashion in order to allow information to be read by means of visual scanning (2), provide tools for producing visual displays and measurements (3), and display automatically generated image processing results (4). Specific to this embodiment of the invention based on display contexts is the fact that they are not strictly oriented to layout and data, as is the case for a competitor, but rather also achieve the following:

1) task-conscious layout (mapping for reporting)
2) filtering of data (e.g. VRT (Volume Rendering Technique) preset for a 3D data record)
3) selection of data contents (summary of successions/series)
4) definition of the layouts (arrangement of data, numbers and size of segments)
5) image synchronization/registration
6) tool sets which are determined by the clinical task to which the display context relates
7) incorporation of processing results which have been produced by other agents.

The right-hand side of FIG. 2 shows the graphical user interface 25 which relates to the reporting (“Reporting UI”). The fields 27a to 27c display the report sections which the report has. The field 27b is activated, and hence the report section WS 2. This is equivalent to activation of the display context DU2 (field 26b), as illustrated by the arrow running between the fields 26b and 27b.

The active report section WS 2 comprises a few subordinate data elements 28, in this case a table for measurement data and assessments of lesions. The arrow labeled B indicates the relationship between a data element of the display context and the data element 28.

Finally, the graphical user interface 25 also comprises a row 29 for a conclusion and a row 30 for details relating to evidential images which need to be presented in the report, so that the treating doctor can form the diagnosis and is informed about the position and size of the lesions if appropriate. The latter is particularly important when the report is taken as a basis for planning an operation or arranging radiotherapy, for example.

The clinical indication of the case is also used to call a report template (reporting template). This comprises the user interface report (1), a worksheet (2) and a data file (3). The report worksheet is a form and comprises a plurality of documentation areas (worksheet sections). The construction of the sections follows the same logic, oriented to clinical questions, as that of the display contexts. Clinical tasks are performed in order to produce information (clinical evidence). The clinical evidence produced by different agents (primary agents such as radiologists or doctors and secondary agents such as technologists or CAD) in order to answer a clinical question are documented in appropriate sections of the worksheet. The worksheet therefore documents the output or the result from clinical tasks and structures this output in different worksheet sections.

The layout of the worksheet, the types of worksheet sections and the design of the sections are defined by the template. The template is designed to present the clinical information from a clinical examination and to summarize it so as to include the case (e.g. CT cardiac examination).

The worksheet sections are prepared in order to add information from clinical tasks and measurement tools, e.g. quantitative coronary analysis performed during a cardiac examination. Depending on the properties of the evidence (output or result), i.e. depending on the clinical task or the tool, the worksheet section provides suitable documentation elements, e.g. measured values are presented in tables or findings are presented in anatomical diagrams or free text fields. This means that the clinical task also defines the worksheet sections and the tools for documenting the task. Input data for the worksheet sections may be present in the form of qualitative (text) or quantitative data which are produced either by coarse estimation or by manual, semi-automatic or automatic measurement tools. These input data can be produced manually or verbally (dictation or measured-value transfer).

The assignment and transfer of reading input data to a worksheet section sets up the connection between reading and reporting. Structured reporting takes place on two levels (FIG. 2): the worksheet section takes on the structure of the diagnostic process (clinical questions and tasks), i.e. the addressed clinical questions are shared information. The design of the worksheet sections allows structured reporting within a section, i.e. the report template knows the clinical task and the tools. The system routes the input data from the reading to a section which is associated with these input data (see arrow B in FIG. 2).

The user interface for the reading 24 and the user interface for the reporting 25 are connected to one another by means of the diagnostic process 23.

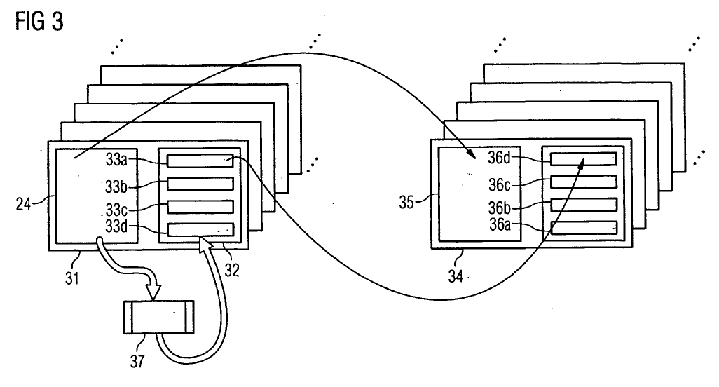

FIG. 3 shows the relationship between a display context and a report context. A display context 31 is part of a multiplicity of display contexts. Each display context is provided for managing a specific diagnostic task. For this purpose, the selected display context 31 contains an area 24 which is provided for examinations data, such as images from imaging methods. An area 32 of the display context 31 is provided for diagnosis data and in this case comprises four diagnosis data fields 33a to 33d. In the course of the appraisal of the examination data by a user, the user enters data into the diagnosis data fields 33a to 33c which are based on his observations and conclusions.

Entry can be made using a keyboard, a mouse, a trackball, a joystick or else using a microphone with connected voice recognition. In this case, it is possible for particular diagnosis data fields to be filled automatically. Suitable automatically determinable diagnosis data are particularly statistical evaluations of the examination data, and also metadata, which are stored together with the examination data. By way of example, these metadata may be the date and the time at which a scan is taken, the radiological appliance used, operating parameters for the radiological appliance, etc.

A program (module) 37 takes care of the transmission of the data to be entered automatically from the examination data to the diagnosis data field 33d.

The right-hand side of FIG. 3 shows the report context 34, which is associated with the display context 31. The report context 34 is part of a multiplicity of report contexts, as indicated in FIG. 3. Like the display context 31, the report context 34 also contains an area 35 for the examination data and a few diagnosis data fields 36a to 36d. Arrows between the display context and the report context clarify the association between the display context 31 and the report context 34. In this connection, attention is drawn to the fact that the display context 31 and the report context 34 are to be understood as data structures which indicate which data (examination and diagnosis data) need to be pooled for a diagnostic task. The similar presentation of display context 31 and report context 34 which is chosen in FIG. 3 does not mean that the display created using the display or report context (e.g. on a screen or a printed sheet of paper) must likewise be of similar appearance. It is also possible for the report context not to reflect all the data which the display context contains, but rather for the data relevant to the diagnostic task to be selected.

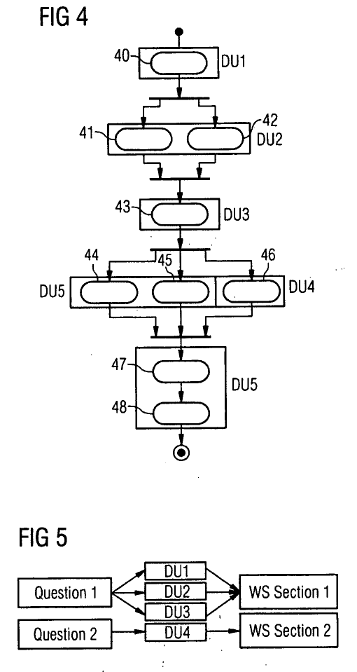

FIG. 4 shows a diagnostic evaluation process on which the reporting is based. In FIG. 4, the rectangles DU1 to DU5 respectively represent display contexts. The abbreviation DU stands for “Display Unit”. The oval shapes 40 to 48 represent clinical questions. The progression or tree shown in FIG. 4 shows the structure of the radiological reading and report process as a sequence of clinical questions. The underlying structure of the answering of clinical questions is used for optimized design of the reading and report user interfaces.

The clinical questions to be answered, i.e. the clinical evaluation process, are mapped onto display contexts in the user interface. For each clinical task requiring a clinical question to be answered, one or more display contexts are created. The display contexts entail firstly a piece of technical logic stipulating which data should be displayed for a clinical task and secondly a piece of logic which determines how these data need to be arranged in a display.

The display contexts improve the diagnosis by providing an ordered review process in a plurality of review steps. A combination of display contexts in a sequence of user interface elements represents the logic of the clinical evaluation process. A particular sequence of intelligent displays can be set up in order to systematically examine images and other evidence and in order to gradually eliminate possible reasons for a particular suspected diagnosis. A set of intelligent display layouts sets up a reading protocol and is started by the clinical indication of the case. These display contexts are a process model for how it is possible to arrive at the correct diagnosis and to control the reading. Although the process is sequential, new image data and layouts are not provided for all questions.

The clinical questions to be answered, i.e. the reading protocol, are mapped onto the user interface using the display contexts. The radiologist is able to change between the various displays provided, in order to answer various clinical questions using these image displays and the associated image manipulation tools. The purpose of display contexts is to implement an ordered, rational, accelerated and accurate clinical evaluation process which has minimum interruptions. Depending on the indication, specific or unspecific reading protocols are set up. The more specific the indication, the more clearly the tools and the layouts are able to be determined.

In summary, the clinical question or the clinical task stipulates the context in which results are produced, transferred and documented in a report environment based on the question/task. This means that findings which are produced within a clinical task are documented in the context of this task. The results produced within a display context are therefore mapped by means of rules for a report section. The context of the clinical question is used to allow structured reporting and voice recognition to be brought together, since the dictated input data are routed to a defined section of the worksheet.

FIG. 5 illustrates how each display context (DU) which is set up for answering a clinical question is mapped onto a section of the report environment and automatically assigns the diagnostic evidence to a documentation section.

For the mapping between the reading and reporting tasks, the same basis is used, since the underlying structure creates a common context which is used as a reference. The reference to this process allows a common context to be created between the reading and reporting tasks (FIG. 5), since both relate to the same clinical questions. Each question which is handled during the reading is mapped directly onto the reporting. This is done by virtue of the results produced for a question being able to be documented in the context of the question during the reporting. The common context allows simple documentation as a result of the interchange of data between the reading and reporting environments. This mapping of clinical results which are produced within the context of a clinical question achieves a high level of integration between reading and reporting (FIG. 2). The fact that the clinical questions to be answered and the results to be reported are explicitly started during the actual reading operation is a new kind of approach in comparison with today's approaches. The new approach means that a predetermined review process is started and this review process is mapped onto the reading and reporting user interface.

It is generally the intention to map 1-n clinical questions explicitly onto a worksheet section (FIG. 5). If this is correct, the calling of a display context in the reading user interface can start a section of the worksheet in the report environment. This makes it possible to control the report environment for the reading (FIG. 2). Normally, it can be assumed that clinical tasks which involve system algorithms each have an explicit worksheet section, e.g. left ventricle analysis (in the case of CT cardiac examination).

Explicit mapping of a display context to a worksheet section (FIG. 5) is a prerequisite for structured reporting within a worksheet section. Software tools (e.g. tumor measurement tools) which are used in the context of the clinical task (e.g. in order to eliminate a tumor) are assigned to an area or a field within the worksheet section. Without this explicit association, it would be ambiguous as to whether results of the reading need to be documented. Structured reporting is therefore possible only if the assignment of measurements and text which are produced in the context of a clinical task is mapped explicitly. Although the reading and the reporting are coupled, the reading user interface is not controlled by the worksheet section. This is because:

1) there is no 1:1 mapping of the user interfaces, i.e. of display context to worksheet section (FIG. 5),
2) a dependency in this direction could result in unintentional starting of reading tasks (display contexts) when navigating through the report,
3) the order of the reading is not necessarily the order of the report.

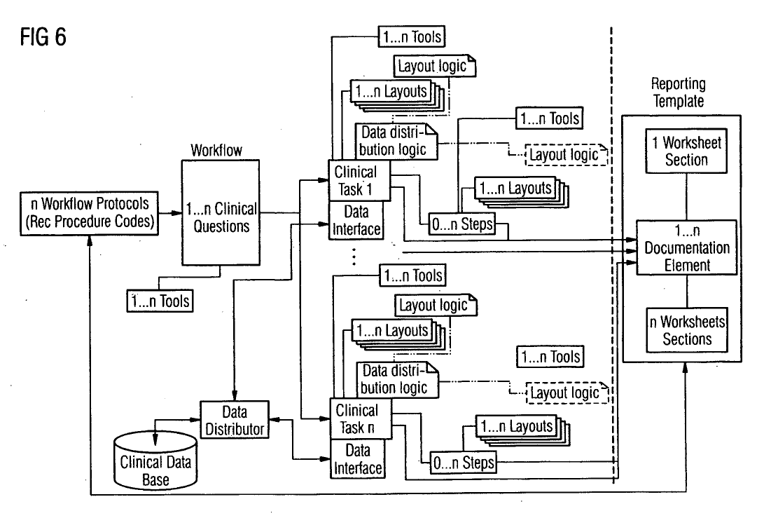

FIG. 6 shows the software architecture in the form of what is known as a high level software architecture diagram. The letter “n” used in FIG. 6 and in the description can assume difference values, that is to say can represent different quantities, in particular.

The far left of FIG. 6 shows an object which is labeled “n Workflow Protocols (Rec. Procedure Code)”. This object can be regarded as the starting point. On the basis of an input by a user, one protocol is selected from the n available workflow protocols. The user's input is based on what radiological examinations have been made on the affected patient and what is suspected to be the clinical picture of the patient.

From the starting point object, an arrow points to the right to an object labeled “Workflow”. This object contains the information which is valid for the selected workflow. The workflow is broken down into 1 . . . n clinical questions. In addition, the workflow is combined with 1 . . . n tools which could be accessed by a user during execution of the workflow. The collection of the 1 . . . n tools is accessible via a user interface and can therefore be changed or added to, e.g. when new tools become available.

Each clinical question requires one or more clinical tasks to be managed. FIG. 6 shows the clinical task 1 and the clinical task n as representative of all n clinical tasks.

Each clinical task may have the following associated objects: tools (1 . . . n Tools), layouts (1 . . . n Layouts), worksteps (0 . . . n Steps). The work steps may in turn have associated tools and layouts.

A piece of distribution logic undertakes the selection, filtering and registration of data within the data and organization structure of a clinical task. In addition, the data and organization structure of a clinical task has an interface to a data source (“Data Interface”). This interface connects the clinical tasks to a data distributor. The data distributor in turn is connected to a clinical database.

A piece of layout logic undertakes the layout and the synchronization of the data.

On the right-hand side of FIG. 6, the report environment is mapped. A report template (“Reporting Template”) is called on the basis of the selected workflow protocol in parallel with the workflow. The report template contains 1 . . . n worksheet sections. Each worksheet section is in turn connected to a multiplicity of documentation elements (“1 . . . n Documentation Element”).

Connections between the reading environment (to the left of the dashed line) and the report environment (to the right of the dashed line) exists between a clinical task and/or a work step, on the one hand, and documentation elements, on the other.

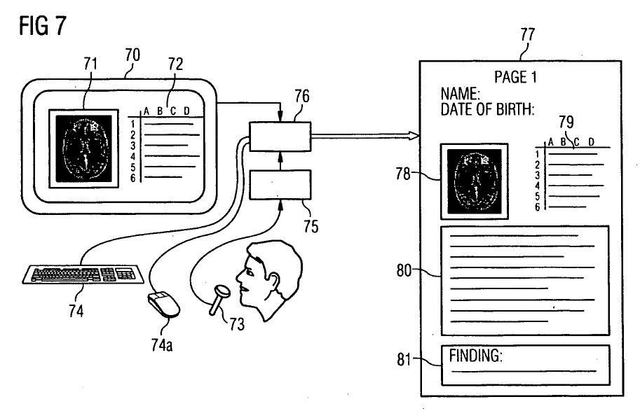

FIG. 7 shows an application example of the present invention. Examination data 71, 72 are displayed to a user on a screen 70, said examination data being compiled and arranged in line with a display context. The user appraises the examination data and derives diagnosis data therefrom and from his specialist knowledge. The user can input the diagnosis data using a keyboard 74, a mouse 74a, or a microphone 73. Alternative input devices are also conceivable, such as a trackball, a graphics tablet or a joystick. The input diagnosis data are processed in a software module 76, with the diagnosis data which are input via the microphone 73 being processed beforehand by a voice recognition unit 75 which converts voice signals in to a text format, for example.

The examination data and the diagnosis data are transmitted to a report 77. Usually, the report contains details which allow the patient to be identified (“name, date of birth”). Relevant examination data are shown in areas 78, 79 of the report, so that the medical conclusions mentioned in the report can be comprehended. The diagnosis data which are input by the user appear in a text field 80 of the report. The medical finding is shown in a text field 81 labeled “finding”.

The following list compiles various aspects of the invention once again:

the framework of clinical questions, clinical tasks and the documentation of clinical results allows structured integration of reading and reporting, which is a usual thought pattern for any diagnostic imaging in radiology, specifically regardless of the agent (e.g. technologist, radiologist or CAD).

Use of this framework rationalizes the diagnostic process into a coherent evaluation process, instead of selecting hanging protocols or layouts on a random basis.

Since the diagnostic process and its settings are largely predetermined, online preparations are greatly reduced.

Several advantages of the use of display contexts (DUs) are:

display contexts provide prepared layouts, which means that layouts do not need to be produced during reading and images do not (any longer) need to be assigned to the layouts (this reduces the complexity required for the arrangement).

Display contexts are set such that diagnostic information can be quickly recorded visually (e.g. size and position of images), specifically in the manner determined by the present clinical task

settings (e.g. synchronizations) are automatically applied on the basis of the benefit for the clinical task

Display contexts include a selection of tools which are specific to the clinical task. Thus, the tools do not need to be chosen from a large set of options; this reduces the search for the correct tools.

Display contexts contain prepared visual displays (e.g. VRT) and image processing results (e.g. vessel segmentations) which are produced automatically on the basis of the clinical indication or which are produced by secondary agents. This allows image processing to be integrated into the reading process of the primary agents (radiologist). This in turn allows distributed and parallel work on clinical tasks.

Display contexts can be used to set up reading protocols and to map them onto the user interface in order to organize the diagnostic workflow in the most efficient manner.

A further increase in efficiency is achieved by matching display contexts to individual preferences.

Display contexts and reading protocols allow reuse and allow continuous optimization of the process.

The reading process is speeded up through the use of protocols, since training with iterative protocols for clinical indications speeds up the performance of work. In addition, the reading protocol is in harmony with the diagnostic process, i.e. the specialist knowledge of the user, so that it benefits from conformity in terms of expectations and simple learnability. This increase productivity.

The integration increases the possibility of using image processing for reading. Hence, the diagnostic process is improved in terms of speed and accuracy (e.g. lung nodule detection).

Display contexts can be used to integrate image processing applications into the diagnosis process. Since the diagnosis process is defined, it is possible to determine for what clinical question an image processing result is relevant, and the result can be provided in the context of this clinical question.

In comparison with other software products, all the image data which are relevant to the process are distributed over the display contexts, i.e not only a hanging protocol is provided for the start of the process.

Owing to the mapping of the environments during the reading, the diagnosis can be prepared and also the report can largely be produced during reading.

The mapping between reading and reporting allows automatic or semi-automatic reporting, since the production of text parts (for normal and abnormal findings and for clinical conclusions) on the basis of measured values can be assigned to worksheet sections or elements.

The worksheet sections assist diagnosis using a structured documentation process; if the content of the report user interface is intended to be partially preconfigured, they provide a guide line for reading.

Since the design of the worksheet determines what kind of information should be reported, quality assurance is implemented for radiological diagnostics. The structure in the report user interface simplifies structured reporting; this means quality assurance through systematic description.
The mapping of reading and reporting on the basis of a common structure make it simpler for the radiologist to report using structured reporting and hence for a recipient to read the report.

The mapping of environments assists in the natural documentation workflow of the doctor, since this can be managed at the same time as the reading.

Reporting using iterative report templates and worksheets allows users to increase the reporting output through training and less documentation complexity.

The prior certainty of the diagnosis process and the joint context use allow reports to be produced “blind”, the focus being on the images, because the context of the reading is mapped onto the context of the reporting. For the results produced during reading, there are target documentation elements (e.g. a table for all the output data from an evaluation tool) which automatically pick up the input data. This guarantees the correct transfer of reading results. The joint context use means that fewer focus changes between user interfaces and fewer orientation movements are required. Visual distraction is reduced, since the user is rendered able to produce the report for the most part with the focus on images and evidential data.

The explicit association with the reading and reporting environment allows other agents, such as an efficient measuring algorithm or a technologists to contribute to the report too, since the results can be mapped onto worksheet sections using clinical questions.

The following example illustrates the invention as used in a cardiac examination. The example concentrates only on part of the workflow.

A patient shows symptoms of coronary artery disease. On the basis of the symptoms, a medical authority assigns the patient an indication (“Suspicion of CHD”) and an acquisition protocol (“CT cardio”). This indication is mapped within the software system onto a reading protocol (i.e. 1-n clinical questions) and a report template.

The reading protocol defines parts of the screen layout. It is predetermined by rules which are stipulated by the order in which the display contexts (DUs) are displayed. The reading protocol (technically the “task flow”) entails a description of parts of the user interface framework (general aspects) and a description of the type and number of display contexts, including image data, layout grids, arrangement and size of the images, tools for the clinical task, etc. For the cardiac case, it is necessary for a few clinical questions to be answered.

The background for the evaluation process is to obtain an overview of the cardiac situation, to determine a suitable reconstruction for the quantitative coronary analysis, to perform stenosis analysis and to check the data record for additional cardiac findings. For this purpose, three display contexts (DUs) have been created and these are started by the indication. A few clinical questions are answered in the context of the first display context (“Morphology”). This display context is also used to determine the input data for the second display context (“QCA”).

Thirdly, there is a display context which has been created for examination in terms of additional cardiac findings and the thoracic/lung region (“Extra Cardiac”). When the reading environment is opened, a display context (and hence a clinical task) is selected. On account of the explicit association within a section of the reporting environment, a common context is established.

By way of example, the display context “QCA” corresponds to the worksheet section “QCA”. When the display context “QCA” is activated, all the input data are transmitted to the worksheet section “QCA”. If the user, by contrast, wishes to document a finding which he has found in a context other than the one corresponding to the worksheet section, he can override this mechanism by manually activating the desired worksheet section in the reporting environment and by placing the focus therein.

The report template for “QCA” would entail diagrams, for example, to locate the stenosis, tables and free text input fields. Tools (e.g. stenosis diameter) within the software interface are provided in the context of the clinical task and generically for the indication. The display context “QCA” provides the tools for the visual display (e.g. coronary segmentation) and measurement of the coronary artery. If one of the tools determined by the clinical task “QCA” is then used, its output data (i.e. the output data from the clinical task) are automatically transferred to the relevant worksheet. In addition, the output data for some tools are not assigned only to a worksheet section, but rather also to an element, in the report template. In this example, the measurement data produced by the stenosis quantification tool (e.g. coronary diameter) would be assigned to a table in the worksheet section “QCA”. This table is an element which is defined in the report template, and each cell in the table would pick up a dedicated measured value.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for producing a medical report, comprising:
provisioning medical examination data in a display context selected from a multiplicity of display contexts;
capturing diagnosis data which relate to the selected display context and to the medical examination data; and
automatically converting the captured diagnosis data into a report context, the report context being associated with the selected display context.

2. The method as claimed in claim 1, wherein the display context comprises a multiplicity of diagnosis data fields, wherein the report context comprises a multiplicity of report data fields, and wherein each report data field from the multiplicity of the report data fields has a respective associated diagnosis data field associated with it from the multiplicity of the display data fields.

3. The method as claimed in claim 2, further comprising:
combining each report data field, from the multiplicity of the report data fields, with the respective associated diagnosis data field, wherein the combining is performed before the automatic conversion.

4. The method as claimed in claim 1, further comprising:
provisioning at least one clinical question in the display data structure, before the provisioning of the medical examination data in a display context, wherein the capturing of the diagnosis data comprises the capturing of an answer to the at least one clinical question.

5. The method as claimed in claim 4, wherein the answer to the clinical question is taken as a basis for determining a subset from the multiplicity of the display contexts, which are subsequently able to be selected for the currently valid display context.

6. The method as claimed in claim 4, wherein the report context is explicitly associated with the selected display context by way of the at least one clinical question.

7. The method as claimed in claim 1, wherein the display context comprises information for at least one of the conditioning, the arrangement and the graphical presentation of the medical examination data.

8. The method as claimed in claim 1, wherein the diagnosis data are at least in part captured audibly and processed by way of voice recognition.

9. The method as claimed in claim 1, further comprising:
analyzing the diagnosis data, wherein the diagnosis data are distributed over specific sections of the report context which correspond to the respective diagnosis data using a result from the analysis.

10. The method as claimed in claim 1, wherein rules for processing the diagnosis data are executed during the converting of the diagnosis data into the report context.

11. A computer program product for processing medical findings data with a computer-readable medium and with computer program code segments, in which the computer, having loaded the computer program, is prompted to carry out the method as claimed in claim 1.

12. A system for producing a medical report, comprising:
a display module, designed to produce and initialize display contexts;
a reporting module, designed to produce and fill out report contexts, wherein the filling out of a report context includes using data from a display context which is connected to a respective report context; and
an association module, designed to associate each of the display contexts with a report context.

13. The method as claimed in claim 5, wherein the report context is explicitly associated with the selected display context by way of the at least one clinical question.

14. A computer readable medium including program segments for, when executed on a computer device, causing the computer device to implement the method of claim 1.

15. A system for producing a medical report, comprising:
means for provisioning medical examination data in a display context selected from a multiplicity of display contexts;
means for capturing diagnosis data which relate to the selected display context and to the medical examination data; and
means for automatically converting the captured diagnosis data into a report context, the report context being associated with the selected display context.
